(19) United States
(12) Patent Application Publication
(10) Pub. No.: US 2021/0306172 A1
(43) Pub. Date: Sep. 30, 2021

(54) UNAUTHORIZED PARTICIPANT EXCLUSION FROM ONLINE MEETING

(71) Applicant: Lenovo (Singapore) Pte. Ltd., Singapore (SG)

(72) Inventors: Tobias Christensen, San Francisco, CA (US); Matthew William Fardig, Boonville, IN (US); Philip L. Childs, Fort Wayne, IN (US)

(21) Appl. No.: 16/834,802

(22) Filed: Mar. 30, 2020

(51) Int. Cl. H04L 12/18; H04L 29/06

(52) U.S. Cl. CPC H04L 12/1822; H04L 12/1831; H04L 63/0861; H04L 63/083; H04L 63/102

(57) ABSTRACT

One embodiment provides a method, including: identifying, based upon a permissions policy, a list of authorized participants associated with at least one segment of an online meeting; identifying, using at least one identity-determining technique, an identity of each participant that joins the online meeting; determining, by comparing the identity of each participant against the list of authorized participants, whether an unauthorized participant is present in the at least one segment; and preventing, responsive to determining that the unauthorized participant is present, the unauthorized participant access to meeting data associated with the at least one segment. Other aspects are described and claimed.

### BACKGROUND

Individuals frequently utilize information handling devices (“devices”), for example laptop and/or personal computers, tablet devices, smart phones, and the like, to participate in remote meetings. More particularly, an individual may utilize their device to connect to these remote sessions via a meeting application. Using the meeting application, an individual may interact and communicate with other meeting participants (e.g., via audible input, text input, a combination thereof, etc.), some or all of which may be located in a different geographic location.

### BRIEF SUMMARY

In summary, one aspect provides a method, comprising: identifying, based upon a permissions policy, a list of authorized participants associated with at least one segment of an online meeting; identifying, using at least one identity-determining technique, an identity of each participant that joins the online meeting; determining, by comparing the identity of each participant against the list of authorized participants, whether an unauthorized participant is present in the at least one segment; and preventing, responsive to determining that the unauthorized participant is present, the unauthorized participant access to meeting data associated with the at least one segment.

Another aspect provides an information handling device, comprising: a processor; a memory device that stores instructions executable by the processor to: identify, based upon a permissions policy, a list of authorized participants associated with at least one segment of an online meeting; identify, using at least one identity-determining technique, an identity of each participant that joins the online meeting; determine, by comparing the identity of each participant against the list of authorized participants, whether an unauthorized participant is present in the at least one segment; and prevent, responsive to determining that the unauthorized participant is present, the unauthorized participant access to meeting data associated with the at least one segment.

A further aspect provides a product, comprising: a storage device that stores code, the code being executable by a processor and comprising: code that identifies, based upon a permissions policy, a list of authorized participants associated with at least one segment of an online meeting; code that identifies, using at least one identity-determining technique, an identity of each participant that joins the online meeting; code that determines, by comparing the identity of each participant against the list of authorized participants, whether an unauthorized participant is present in the at least one segment; and prevent, responsive to determining that the unauthorized participant is present, the unauthorized participant access to meeting data associated with the at least one segment.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of preventing unauthorized participants from accessing meeting data.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Mixed online meetings (“meetings”) are those in which participants may connect to the meeting using various connection mediums. Using a SKYPE meeting as an example, one participant may join the meeting through the SKYPE application directly (i.e., by connecting to the SKYPE meeting via the participant's personal SKYPE profile), another participant may join the SKYPE meeting by calling into the meeting using their personal device (e.g., smart phone, etc.), whereas a group of other participants may join the SKYPE meeting by calling in from a shared device (e.g., a conference phone, etc.). SKYPE is a registered trademark of Microsoft Corporation in the United States and other countries.

The diversity of available connection methods allowed for in meetings enables users to join the meeting room using a connection medium that works best for their contextual situation. However, this connection flexibility may not only make it difficult to determine the identities of each participant in attendance but it may also make it difficult to prohibit unauthorized individuals from attending the meeting or attending certain portions of the meeting. In situations where an unauthorized individual does gain access to a private meeting, they may be able to obtain various types of sensitive information that was not intended for public dissemination.

Currently, solutions exist that may increase the barriers to entry for the meeting. For example, some meetings may require participants to enter a username/password combination, a pin code, some other type of authorization input, etc., before granting the participant access to the meeting. Although these solutions are effective to some degree, they are not foolproof and many existing authorization techniques can be spoofed. Additionally, these additional security measures create more barriers to meeting entry for authorized participants, which may be burdensome and inconvenient, especially for individuals that attend remote meetings on a frequent basis.

Accordingly, an embodiment provides a novel method for prevent access to meeting content for unauthorized participants. In an embodiment, a list of authorized participants associated with at least one segment of a meeting may be identified by referencing a permissions policy (e.g., obtained from a meeting invite, another authoritative source, etc.). An embodiment may then identify an identity of each participant that joins the meeting using one or more identity-determining techniques. Thereafter, an embodiment may determine whether an unauthorized participant is present in the meeting by comparing the list of authorized participants to the identities of present participants. If an unauthorized participant is determined to be present, an embodiment may thereafter prevent that individual access to meeting data (e.g., by ceasing display of meeting data, by dynamically removing the unauthorized participant from the meeting room, etc.). Such a method may therefore maintain ease of meeting access while still ensuring meeting privacy and security.

The illustrated example embodiments will be best understood by reference to the figures. The following description is intended only by way of example, and simply illustrates certain example embodiments.

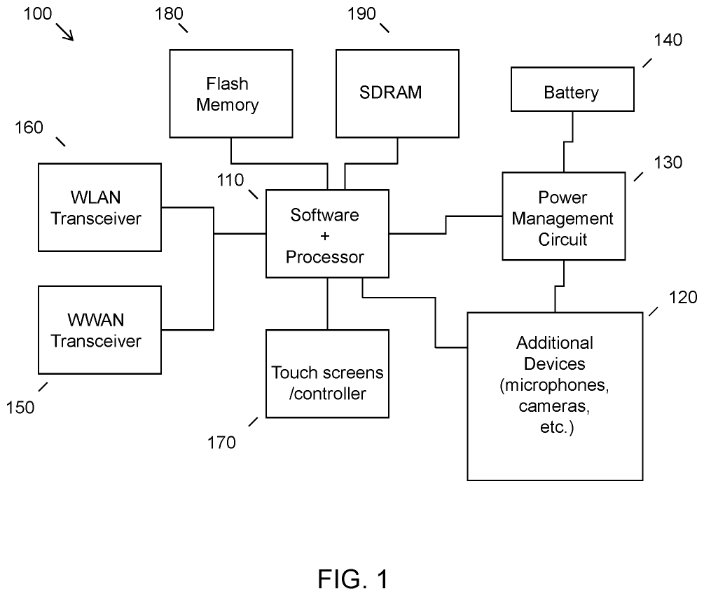

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, etc. System 100 often includes one or more touch screens 170 for data input and display/rendering. System 100 also typically includes various memory devices, for example flash memory 180 and SDRAM 190.

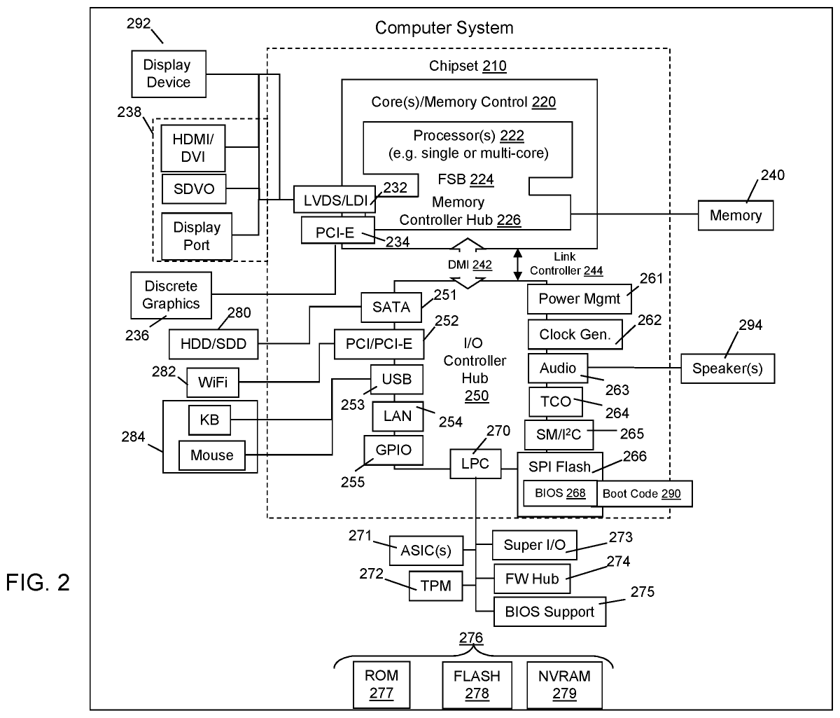

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling circuitry, as for example outlined in FIG. 1 or FIG. 2, may be used in devices capable of supporting mixed meetings. For example, the circuitry outlined in FIG. 1 may be implemented in a smart phone or tablet embodiment, whereas the circuitry outlined in FIG. 2 may be implemented in a laptop.

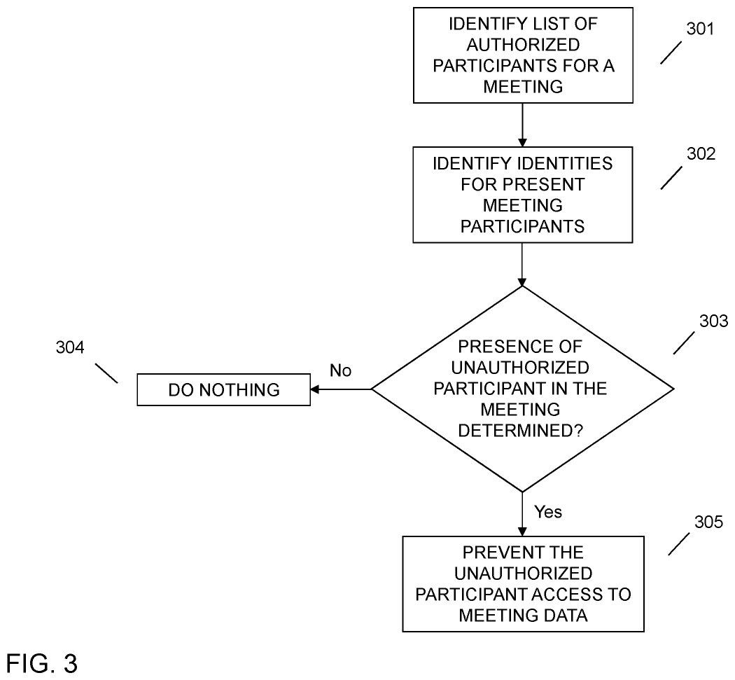

Referring now to FIG. 3, an embodiment provides a method for preventing unauthorized participants from accessing meeting content. At 301, an embodiment may identify a list of authorized participants associated with at least one segment of a meeting. In an embodiment, the meeting may be facilitated by utilizing a meeting application resident on a device. As used herein, a meeting may refer to a mixed online meeting in which participants may join the meeting from two or more connection mediums. Non-limiting examples of potential connection mediums include: a profile on the meeting application directly, a personal device (e.g., a phone dial-in from their smart phone, tablet, laptop device, etc.), a shared device (e.g., a conference phone, monitor, or hub, etc.), and the like. Participants in the meeting may provide input to the meeting using whatever input device is available to them (e.g., cameras, microphones, pin-pads, external devices such as a mouse or stylus, etc.).

In the context of this application, an authorized participant may be an individual that has been identified in some way as having permission to be made privy to content expected to be presented in the meeting. Identification of these individuals may be manual (e.g., by a meeting organizer, an authoritative figure, etc.) or dynamic (e.g., by a system, etc.). Regarding the latter, an embodiment may facilitate dynamic identification of authorized participants by first identifying a context of the meeting (e.g., by pulling information from a meeting invite or another source, etc.) and thereafter identifying the individuals that may be associated with that context (e.g., those individuals that are closely tied to a discussion topic of the meeting, those individuals that supervise a work project discussed in the meeting , those individuals that have a security clearance high enough to be able to listen to information shared in the meeting, etc.). Indications of these authorized individuals may be recorded and stored in an accessible list (e.g., stored locally on the device supporting the meeting application, stored remotely on another device or server, etc.).

In an embodiment, a single meeting may be divided into two or more segments. More particularly, different matters may be discussed during different portions of the meeting. In an embodiment, the list of authorized participants may vary between segments. Stated differently, the authorization designations of participants may change throughout the meeting as different topics are discussed. For example, given a meeting divided into three segments, Participant A may be authorized to participate in segments one and two (e.g., where segment one is associated with a discussion of previous projects and segment two is associated with a discussion of future projects, etc.) but may not be authorized to participate in segment three (e.g., where segment three is associated with company policy discussions, etc.). The segments may be manually delineated or, alternatively, a segment switch may be dynamically identified by the system. Regarding the latter, an embodiment may identify a segment switch by identifying (e.g., using one or more audio and/or visual analysis techniques, etc.) that a change in discussion topics/content has been effectuated.

At 302, an embodiment may identify identities for present participants in the meeting. The determination of these identities may be facilitated using one or more different identity determination techniques. These techniques may include, but are not limited to: recognizing a username/passcode pair provided by the participant, recognizing a pin number provided by the participant, obtaining caller identification information associated with the participant, performing vocal or facial recognition of the participant and comparing the results to known audible and/or facial characteristics of a known individual, identifying device network setting information (e.g. identifying a network utilized by the participant to join the meeting, etc.), identifying device proximity information (e.g., identifying which known device signatures are within a predetermined distance of a conferencing hub device, etc.), identifying an input speed of the participant and comparing the input speed to a known individuals' known input speed, identifying word choices utilized by the participant and comparing the identified word choices to an individuals' known and/or frequently used word choices, and the like. In an embodiment, the identity determination may occur at substantially the time when a participant attempts to access a meeting or when an embodiment identifies a meeting segment switch. Additional details regarding the identity identification process may be found in commonly owned U.S. patent application Ser. No. 16/834,707, filed on Mar. 30, 2020, which is incorporated by reference herein.

At 303, an embodiment may determine whether an unauthorized participant is present in at least one segment of the meeting. This determination may be facilitated by accessing the permissions policy (i.e., to identify the list of authorized participants for the meeting or for each meeting segment) and then comparing the list of authorized participants against the identified participants present in the meeting. This determination may be conducted once (e.g., at the outset of the meeting, at the beginning of each meeting segment, etc.) or may be conducted substantially continuously throughout the meeting at predetermined intervals (e.g., every few seconds, every minute, etc.) or responsive to predetermined events (e.g., after each detection of an individual joining the meeting, etc.).

Responsive to determining, at 303, that there are no unauthorized participants present in the meeting or in a meeting segment, an embodiment may, at 304, take no additional action. Conversely, responsive to determining, at 303, that is at least one unauthorized participant present in the meeting or in a meeting segment, an embodiment may, at 305, prevent the unauthorized participant access to meeting data associated with the meeting as a whole or associated with a particular meeting segment. In an embodiment, this access prevention may be facilitated by one or more prevention techniques further described herein.

An embodiment may prevent an unauthorized participant access to meeting data by removing them from the meeting room. In an embodiment, the removal may be substantially immediate (i.e., once the determination decision is complete), thereby effectively preventing the unauthorized participant from ever gaining substantive access to meeting content. An embodiment may continue to remove the unauthorized participant if they repeatedly attempt to access the meeting. Responsive to identifying a predetermined number of attempts by the unauthorized participant to access the meeting (e.g., 1 attempt, 3 attempts, 5 attempts, etc.), an embodiment may provide a notification of this attempted access to a meeting moderator or organizer. The meeting moderator can thereafter review the situation and make a manual decision. For example, upon removal by the system, the unauthorized participant may dynamically be placed into a virtual lobby where they may await a moderator's decision. If a moderator grants access to the unauthorized individual, then they may be moved from the virtual lobby into the primary meeting room.

Additionally or alternatively to the foregoing, an embodiment may transmit (e.g., via any available and appropriate communication means, etc.) new meeting information to the authorized participants. More particularly, an embodiment may provide the authorized participants with a new online meeting destination (e.g., new URL, new meeting room, etc.) or a new access number that they can go or call into. Such methods may make it more difficult for an unauthorized participant to gain knowledge of a meeting destination, thereby making it more difficult for them to attempt to access the meeting.

In an embodiment, an originally authorized participant may be reclassified as an unauthorized participant and thereafter prevented from accessing meeting content. For example, an individual designated as an authorized participant in an earlier meeting segment may be reclassified as an unauthorized participant in a later meeting segment if a system determines, as further described above, that they do not have permission to be made privy to the discussion in the later meeting segment. Additionally or alternatively, an otherwise authorized participant may be reclassified as an unauthorized participant responsive to an embodiment determining that they are attempting to access the meeting from an insecure location (e.g., a public location, a location outside of a designated work area, etc.) or insecure device (e.g., a device that does not contain various necessary security software, etc.).

The various embodiments described herein thus represent a technical improvement to conventional methods for preventing unauthorized access to a private meeting. Using the techniques described herein, an embodiment may be able to identify a list of authorized participants associated with a particular meeting or a particular segment in that meeting. An embodiment may then identify the identity of each participant in the meeting and thereafter determine, by comparing the identity of each participant against the list of authorized participants, whether an unauthorized participant is present in the meeting or meeting segment. Responsive to determining that an unauthorized participant is present, an embodiment may perform an action that prevents the unauthorized participant from obtaining access to meeting content. Such methods may ensure that meeting content, especially sensitive content, is only accessed by the appropriate individuals.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
identifying, based upon a permissions policy, a list of authorized participants associated with at least one segment of an online meeting;
identifying, using at least one identity-determining technique, an identity of each participant that joins the online meeting;
determining, by comparing the identity of each participant against the list of authorized participants, whether an unauthorized participant is present in the at least one segment; and
preventing, responsive to determining that the unauthorized participant is present, the unauthorized participant access to meeting data associated with the at least one segment.

2. The method of claim 1, wherein the permissions policy is obtained from a controlling source.

3. The method of claim 1, wherein the list of authorized participants dictated by the permissions policy is unique to each of the at least one segments.

4. The method of claim 1, wherein the identifying the identity comprises identifying the identity using at least one identity-determining technique selected from the group consisting of: username/password identification, pin number identification, caller identification, voice recognition, facial recognition, device network setting identification, and device proximity information.

5. The method of claim 1, wherein the preventing comprises ceasing sharing of the meeting data.

6. The method of claim 1, wherein the preventing comprises removing the unauthorized participant from the online meeting.

7. The method of claim 1, wherein the preventing comprises placing the unauthorized participant in a virtual lobby.

8. The method of claim 7, further comprising:
granting, responsive to receiving confirmation input by a moderating participant, the unauthorized participant access to the online meeting; and
thereafter transferring the unauthorized participant from the virtual lobby to the online meeting.

9. The method of claim 1, wherein the at least one segment corresponds to a plurality of segments and further comprising dynamically identifying a change from one segment of the plurality of segments to another segment responsive to identifying a content switch.

10. The method of claim 1, further comprising:
identifying, from received location data, a physical location associated with each of the participants; and
reclassifying at least one authorized participant as an unauthorized participant responsive to identifying that the physical location associated with the at least one authorized participant corresponds to an insecure physical location.

11. An information handling device, comprising:
a processor;
a memory device that stores instructions executable by the processor to:
identify, based upon a permissions policy, a list of authorized participants associated with at least one segment of an online meeting;
identify, using at least one identity-determining technique, an identity of each participant that joins the online meeting;
determine, by comparing the identity of each participant against the list of authorized participants, whether an unauthorized participant is present in the at least one segment; and
prevent, responsive to determining that the unauthorized participant is present, the unauthorized participant access to meeting data associated with the at least one segment.

12. The information handling device of claim 11, wherein the permissions policy is obtained from a controlling source.

13. The information handling device of claim 11, wherein the list of authorized participants dictated by the permissions policy is unique to each of the at least on segments.

14. The information handling device of claim 11, wherein the instructions executable by the processor to identify comprise instructions executable by the processor to identify the identity using at least one identity-determining technique selected from the group consisting of: username/password identification, pin number identification, caller identification, voice recognition, facial recognition, device network setting identification, and device proximity information.

15. The information handling device of claim 11, wherein the instructions executable by the processor to prevent comprise instructions executable by the processor to cease sharing of the meeting data.

16. The information handling device of claim 11, wherein the instructions executable by the processor to prevent comprise instructions executable by the processor to remove the unauthorized participant from the online meeting.

17. The information handling device of claim 11, wherein the instructions executable by the processor to prevent comprise instructions executable by the processor to place the unauthorized participant in a virtual lobby.

18. The information handling device of claim 17, wherein the instructions are further executable by the processor to:
grant, responsive to receiving confirmation input by a moderating participant, the unauthorized participant access to the online meeting; and
thereafter transfer the unauthorized participant from the virtual lobby to the online meeting.

19. The information handling device of claim 11, wherein the at least one segment corresponds to a plurality of segments and wherein the instructions are further executable by the processor to dynamically identify a change from one segment of the plurality of segments to another segment responsive to identifying a content switch.

20. A product, comprising:
a storage device that stores code, the code being executable by a processor and comprising:
code that identifies, based upon a permissions policy, a list of authorized participants associated with at least one segment of an online meeting;
code that identifies, using at least one identity-determining technique, an identity of each participant that joins the online meeting;
code that determines, by comparing the identity of each participant against the list of authorized participants, whether an unauthorized participant is present in the at least one segment; and
prevent, responsive to determining that the unauthorized participant is present, the unauthorized participant access to meeting data associated with the at least one segment.
